(19) United States
(12) Patent Application Publication
(10) Pub. No.: US 2014/0029855 A1
(43) Pub. Date: Jan. 30, 2014

(54) IMAGE PROCESSING APPARATUS, IMAGE PROCESSING METHOD, AND PROGRAM

(71) Applicant: Sony Corporation, Tokyo (JP)

(72) Inventors: Soshi Manako, Kanagawa (JP); Takanobu Ujisato, Tokyo (JP)

(73) Assignee: Sony Corporation, Tokyo (JP)

(21) Appl. No.: 13/946,089

(22) Filed: Jul. 19, 2013

(30) Foreign Application Priority Data
Jul. 26, 2012 (JP) 2012-165427

(51) Int. Cl. G06K 9/62

(52) U.S. Cl. CPC G06K 9/6202
USPC 382/192; 382/218

(57) ABSTRACT

An image processing apparatus includes a difference area detection unit and a similarity determination unit. The difference area detection unit is configured to detect a difference area of an input image. The similarity determination unit is configured to calculate a feature amount of a difference area image that is an image of the detected difference area and determine a similarity between the calculated feature amount of the difference area image and a feature amount of a template image for erroneous detection, to determine whether the difference area image is erroneously detected or not.

### BACKGROUND

The present disclosure relates to an image processing apparatus, an image processing method, and a program, and more particularly to, an image processing apparatus, an image processing method, and a program that are capable of reducing erroneous detections of ambient noise in a simpler configuration.

In the past, as a technique for detecting an object with a monitoring apparatus, a difference detection method has been used. In the difference detection method, a real-time image captured just at that moment is compared with a past image captured a little earlier, a difference is detected, and a difference area between the two images is extracted (see, for example, Japanese Patent Application Laid-open No. 2006-014215).

However, such a difference detection method has a problem that ambient noise that is not originally intended to be detected, such as ripples or motions of leaves of a tree, is also detected.

In this regard, Japanese Patent Application Laid-open No. 2000-156852 proposes a method of generating a background image from a plurality of past images on which an identical area is captured and detecting a difference between a real-time image and the generated background image in order to eliminate the influence of the ambient noise.

### SUMMARY

However, in the technique disclosed in Japanese Patent Application Laid-open No. 2000-156852, it is necessary to use a plurality of past images successively captured for a short period of time in order to generate the background image. In the case where an image is captured with a monitoring camera of a low frame rate or with one monitoring camera moving in a wide area, for example, this technique is not suitable. Further, in the case where a monitoring target range is wide, a large number of memories are used to generate and hold a background image.

In view of the circumstances as described above, it is desirable to reduce erroneous detections of ambient noise in a simpler configuration.

According to an embodiment of the present disclosure, there is provided an image processing apparatus including a difference area detection unit and a similarity determination unit. The difference area detection unit is configured to detect a difference area of an input image. The similarity determination unit is configured to calculate a feature amount of a difference area image that is an image of the detected difference area and determine a similarity between the calculated feature amount of the difference area image and a feature amount of a template image for erroneous detection, to determine whether the difference area image is erroneously detected or not.

According to an embodiment of the present disclosure, there is provided an image processing method including: by an image processing apparatus, detecting a difference area of an input image; and calculating a feature amount of a difference area image that is an image of the detected difference area and determining a similarity between the calculated feature amount of the difference area image and a feature amount of a template image for erroneous detection, to determine whether the difference area image is erroneously detected or not.

According to an embodiment of the present disclosure, there is provided a program causing a computer to function as: a difference area detection unit configured to detect a difference area of an input image; and a similarity determination unit configured to calculate a feature amount of a difference area image that is an image of the detected difference area and determine a similarity between the calculated feature amount of the difference area image and a feature amount of a template image for erroneous detection, to determine whether the difference area image is erroneously detected or not.

In one embodiment of the present disclosure, a difference area of the input image is detected, a feature amount of a difference area image that is an image of the detected difference area is calculated, and a similarity between the calculated feature amount of the difference area image and a feature amount of a template image for erroneous detection is determined. Thus, it is determined whether the difference area image is erroneously detected or not.

It should be noted that a program can be provided by being transmitted via a transmission medium or being recorded on a recording medium.

The image processing apparatus may be an independent apparatus or an inner block forming one apparatus.

According to an embodiment of the present disclosure, it is possible to reduce erroneous detections of ambient noise in a simpler configuration.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a configuration example of a monitoring camera system according to a first embodiment of the present disclosure;

FIGS. 2A, 2B, 2C are diagrams showing an example of area division processing;

FIG. 3 is a diagram for describing how to determine positional proximity;

FIGS. 4A and 4B are diagrams for describing a calculation method for a co-occurrence matrix P;

FIGS. 5A, 5B, and 5C are diagrams for describing the calculation method for a co-occurrence matrix P;

FIG. 6 is a diagram for describing the calculation method for a co-occurrence matrix P;

FIGS. 7A, 7B, and 7C are diagrams for describing a determination equation of a similarity in texture feature amount;

FIGS. 8A, 8B, and 8C are diagrams for describing the determination equation of a similarity in texture feature amount;

FIG. 9 is a diagram for describing the determination equation of a similarity in texture feature amount;

FIG. 10 is a diagram for describing the determination equation of a similarity in texture feature amount;

FIGS. 11A, 11B, and 11C are diagrams for describing the determination equation of a similarity in texture feature amount;

FIGS. 12A and 12B are diagrams for describing the determination equation of a similarity in texture feature amount;

FIG. 13 is a flowchart for describing object detection processing;

FIG. 14 is a diagram for describing comparison in detection accuracy based on a type of feature amount;

FIG. 15 is a diagram for describing comparison in detection accuracy based on a type of feature amount;

FIG. 16 is a diagram for describing comparison in detection accuracy based on a type of feature amount;

FIG. 17 is a diagram for describing comparison in detection accuracy based on a type of feature amount;

FIG. 18 is a diagram for describing comparison in detection accuracy based on a type of feature amount;

FIG. 19 is a diagram for describing comparison in detection accuracy based on a type of feature amount;

FIG. 20 is a diagram for describing a monitoring camera system according to a second embodiment;

FIG. 21 is a diagram for describing a distance “d” serving as a parameter of a co-occurrence matrix P in the second embodiment; and

FIG. 22 is a block diagram showing a configuration example of a computer according to an embodiment of the present disclosure.

### DETAILED DESCRIPTION OF EMBODIMENTS

Hereinafter, description will be given on modes for carrying out the present disclosure (hereinafter, referred to as embodiments). It should be noted that the description is given in the following order.

1. First Embodiment (Embodiment in a case where an imaging range of a camera is fixed)

2. Second Embodiment (Embodiment in a case where an imaging direction of a camera is moved to perform wide range imaging)

### 1. First Embodiment

(Configuration Example of Monitoring Camera System)

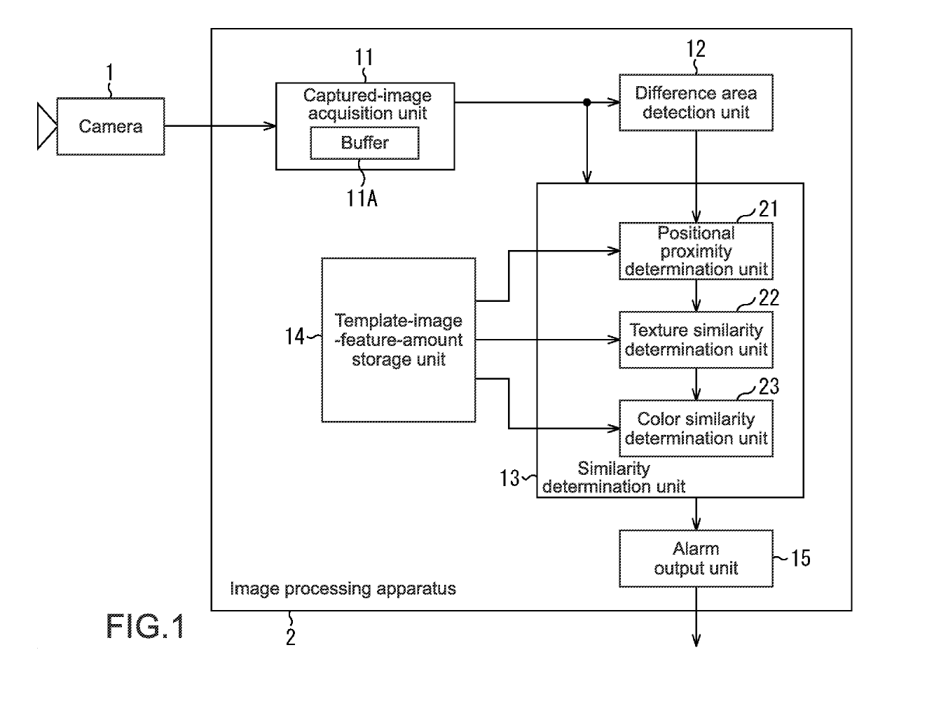

FIG. 1 is a block diagram showing a configuration example of a monitoring camera system according to a first embodiment of the present disclosure.

The monitoring camera system of FIG. 1 includes a camera (monitoring camera) 1 and an image processing apparatus 2. The camera 1 captures an image of an area to be monitored. The image processing apparatus 2 processes the image captured with the camera 1.

For example, the camera 1 captures an image of an area to be monitored at a predetermined frame rate and outputs the captured image to the image processing apparatus 2. For example, the camera 1 outputs a captured image having a resolution of the full high-definition (HD) size (1920 by 1080 pixels) to the image processing apparatus 2. Using the captured image (input image) that is input from the camera 1, the image processing apparatus 2 executes processing of detecting an object in the image. When detecting an object in the image, the image processing apparatus 2 outputs information indicating the detection of an object, by means of sounds, an image, and the like (alarm output).

The image processing apparatus 2 includes a captured-image acquisition unit 11, a difference area detection unit 12, a similarity determination unit 13, a template-image-feature-amount storage unit 14, and an alarm output unit 15. Further, the similarity determination unit 13 includes a positional proximity determination unit 21, a texture similarity determination unit 22, and a color similarity determination unit 23.

The captured-image acquisition unit 11 includes a buffer 11A and temporality holds the captured image supplied from the camera 1 in the buffer 11A.

The captured-image acquisition unit 11 supplies a set of images, among the captured images supplied from the camera 1, to the difference area detection unit 12 and the similarity determination unit 13. One of the set of images is an image captured latest (hereinafter, referred to as real-time image) and the other one is an image captured one image before the latest image (hereinafter, referred to as past image).

The difference area detection unit 12 compares the two images captured at different times of day and extracts, as an area, a sequence of pixels in which a difference in luminance value (pixel value) between corresponding pixels of the two images has a predetermined threshold value or more. Then, the difference area detection unit 12 sets the extracted area surrounded by a rectangle to be a difference area, and supplies information indicating one or more detected difference areas to the positional proximity determination unit 21 of the similarity determination unit 13.

The similarity determination unit 13 determines a similarity in feature amount between a template image for erroneous detection and each (image) of one or more difference areas detected in the difference area detection unit 12, to determine whether the detected difference area is erroneously detected or not. Then, in the case where the detected difference area is not erroneously detected, the similarity determination unit 13 supplies information to the alarm output unit 15, the information indicating that the difference area has been detected. It should be noted that the feature amount of the template image for erroneous detection is stored (registered) in advance in the template-image-feature-amount storage unit 14, as will be described later.

The similarity determination unit 13 compares the difference area and the template image in terms of three types of feature amounts, that is, a position, a texture, and a color. In the case where the difference area and the template image are determined to have a similarity in all the feature amounts, the similarity determination unit 13 determines that the difference area is erroneously detected.

In the similarity determination unit 13, the positional proximity determination unit 21 determines a similarity in feature amount of position, the texture similarity determination unit 22 determines a similarity in feature amount of texture, and the color similarity determination unit 23 determines a similarity in feature amount of color. The similarity determination processing performed by each of the positional proximity determination unit 21, the texture similarity determination unit 22, and the color similarity determination unit 23 will be described later in detail.

In the template-image-feature-amount storage unit 14, three types of feature amounts, a position, a texture, and a color, of a template image for erroneous detection are registered in advance. The template-image-feature-amount storage unit 14 stores feature amounts of a plurality of template images.

It should be noted that the template-image-feature-amount storage unit 14 may store not the feature amounts of the template image but the template image (image for erroneous detection) itself, and the similarity determination unit 13 may calculate feature amounts of the template image in each case. However, if the feature amounts calculated in advance are stored, a calculation time or a memory capacity can be reduced.

When receiving the information indicating that the difference area has been detected from the similarity determination unit 13, the alarm output unit 15 outputs an alarm (warning) indicating that the difference area has been detected. The alarm may be a voice alarm or an image showing a warning, for example. Further, the alarm output unit 15 may transmit position information or image information of the detected difference area to another apparatus via a network. In other words, in this embodiment, the form of the alarm is not limited.

The monitoring camera system of FIG. 1 is configured as described above.

Next, description will be given on details of similarity determination processing performed by the similarity determination unit 13. (Positional Proximity Determination Processing By Positional Proximity Determination Unit 21)

First, positional proximity determination processing by the positional proximity determination unit 21 will be described.

The positional proximity determination unit 21 determines whether the difference area detected by the difference area detection unit 12 is located close to the template image or not. When determining that the difference area is located close to the template image, the positional proximity determination unit 21 determines that the difference area has a similarity in position to the template image. Hereinafter, the positional proximity determination processing of the positional proximity determination unit 21 will be described in more detail.

First, the positional proximity determination unit 21 executes size reduction processing as preprocessing. The size reduction processing is for reducing a pixel size of the real-time image supplied from the captured-image acquisition unit 11. For example, the positional proximity determination unit 21 reduces the size of the real-time image having the full HD size (1920 by 1080 pixels) to the size of XGA (1024 by 768 pixels), SVGA (800 by 600 pixels), or the like).

Next, the positional proximity determination unit 21 performs area division processing on the real-time image that has been subjected to the size reduction processing. The area division processing is for dividing the real-time image into areas based on similar colors. Since the size reduction processing of the real-time image is performed as preprocessing before this area division processing is performed, it is possible to prevent the real-time image from being divided into areas finer than necessary due to a local color distribution and also to perform the area division processing at high-speed.

Various known techniques can be appropriately adopted for the area division processing. For example, area division by a Mean-shift method (D. Comaniciu and P. Meer, “Mean Shift Analysis and Applications”, The Proceedings of the Seventh IEEE International Conference on Computer Vision, 1197-1203 vol. 2, 1999) can be used.

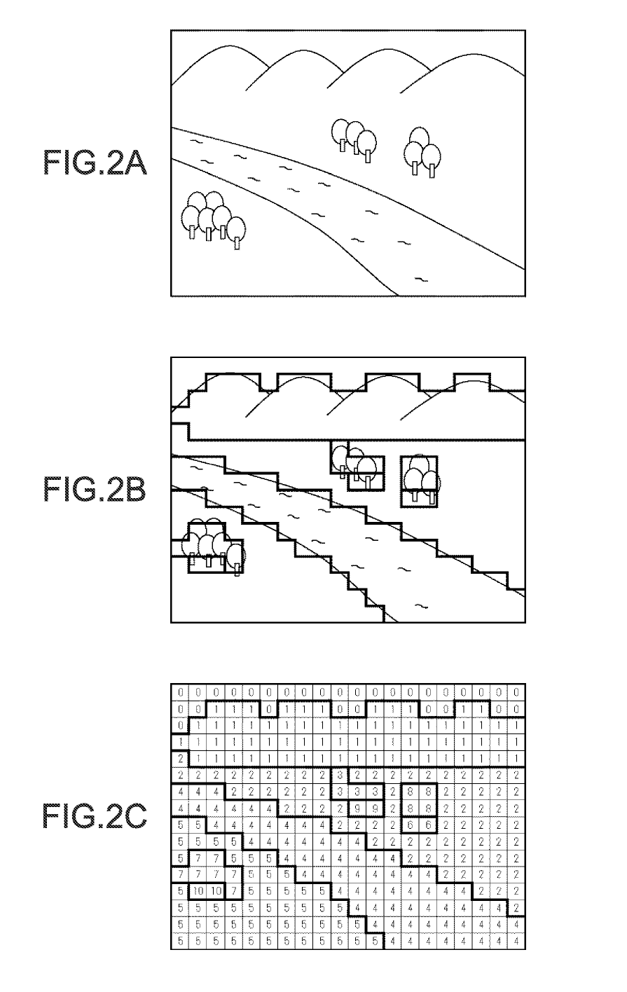

FIGS. 2A, 2B, 2C are diagrams showing an example of the area division processing.

For example, an image shown in FIG. 2A is a real-time image that has been subjected to the size reduction processing. The positional proximity determination unit 21 performs the area division processing on the real-time image. As a result, the image is divided into areas as indicated by thick solid lines shown in FIG. 2B. For example, in each of the divided areas, as shown in FIG. 2C, pixels in the same area are each discriminated by a divided-area flag image. The divided-area flag image has a number uniquely assigned for each area.

Next, the positional proximity determination unit 21 determines positional proximity of a difference area by using results of the area division processing in the follows manner.

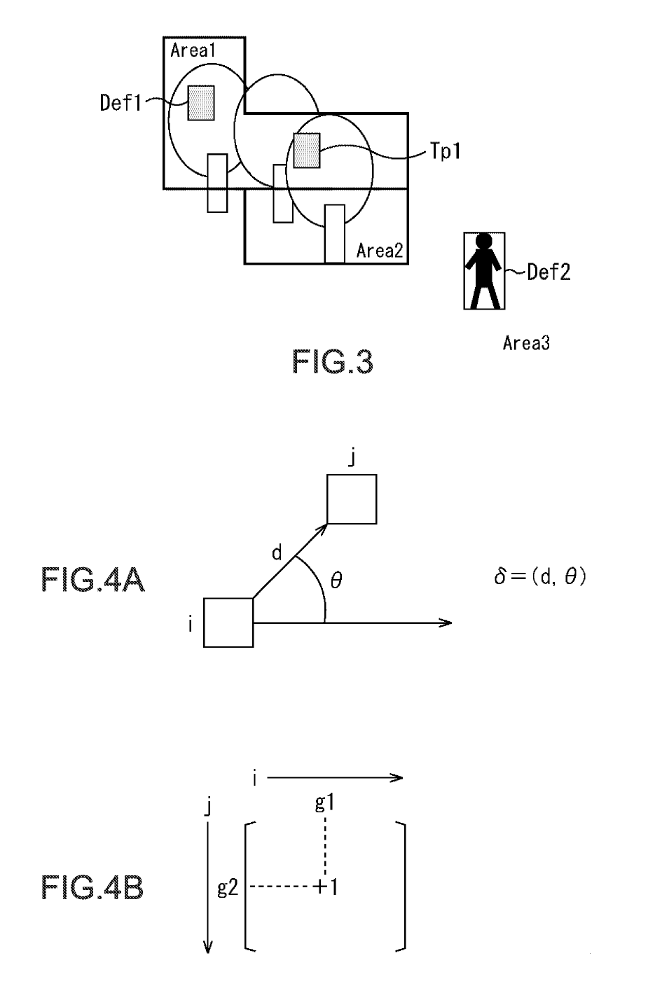

It is assumed that the real-time image is divided into three areas of Area 1, Area 2, and Area 3 by the area division processing as shown in FIG. 3, for example. Further, it is assumed that the difference area detection unit 12 detects two difference areas Def1 and Def2, and the template-image-feature-amount storage unit 14 stores a position of a template image Tp1.

The difference area Def1 exists in the same area as the template image Tp1 as shown in FIG. 3. In this case, the positional proximity determination unit 21 determines that the difference area Def1 has positional proximity to the template image (i.e., has a similarity in feature amount of position).

On the other hand, regarding the difference area Def2, the template-image-feature-amount storage unit 14 does not store a template image existing in the Area 3 in which the difference area Def2 is detected. Therefore, in this case, the positional proximity determination unit 21 determines that the difference area Def2 does not have positional proximity to a template image (i.e., does not have a similarity in feature amount of position).

(Texture Similarity Determination Processing By Texture Similarity Determination Unit 22)

Next, texture similarity determination processing by the texture similarity determination unit 22 will be described in detail.

The texture similarity determination unit 22 calculates a co-occurrence matrix P for each of one or more detected difference areas. The co-occurrence matrix P is obtained by adding up relations in luminance value (pixel value) between two pixels with a constant positional relation within the difference area. The texture similarity determination unit 22 then calculates a feature amount of texture (texture feature amount) using the calculated co-occurrence matrix P. Then, the texture similarity determination unit 22 determines whether the texture feature amount of the difference area is similar to that of the template image.

First, how to calculate the co-occurrence matrix P will be described.

In order to calculate the co-occurrence matrix P for a certain difference area, as shown in FIG. 4A, a relation in luminance value between a predetermined pixel i and a pixel j is focused. The pixel i is within the area. The pixel j is separated from the pixel i by a distance d and an angle θ. Here, a positional relation in which the pixel j is separated from the certain pixel i by the distance d and the angle θ is represented by δ=(d, θ).

In the case where the pixel i has a luminance value of g1 and the pixel j has a luminance value of g2, the texture similarity determination unit 22 performs processing of counting up, by 1, elements of (g1, g2) of the matrix on all pixels having the positional relation of δ=(d, θ) in the area. In the matrix, the luminance value of the pixel i indicates a row direction and the luminance value of the pixel j indicates a column direction, as shown in FIG. 4B.

In this case, the horizontal and vertical size of the matrix shown in FIG. 4B is equal to a gradation level Q of the luminance value of a pixel. However, the texture similarity determination unit 22 does not use a luminance value of the original gradation level (for example, 256 gradations) of the real-time image as it is, but uses a luminance value whose gradation level is reduced to 16 gradations or 4 gradations, for example.

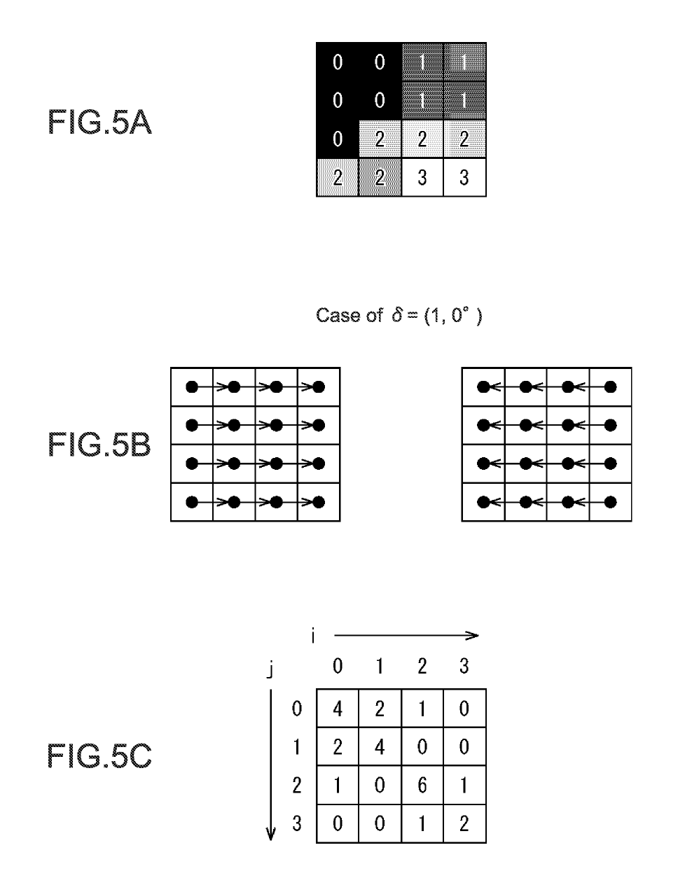

Description will be given on how to create a matrix in the case of a difference area in which the horizontal and vertical size is 4 by 4 pixels and a luminance value of each pixel whose gradation level Q is reduced to 4 gradations (Q=4) has a value shown in FIG. 5A.

In the case where a matrix is created for pixels having a positional relation of δ=(1, 0°) in the difference area shown in FIG. 5A, as indicated by arrows of FIG. 5B, a total of 24 relations between luminance values in a direction from the pixel i to the pixel j (i→j) and a direction from the pixel j to the pixel i (j→i) are focused. When the above-mentioned count-up processing is performed for the relations in those luminance values, the matrix representing a relation in luminance value between two pixels having a positional relation of δ=(1, 0°) is calculated as shown in FIG. 5C. Then, the matrix as the result of the count-up processing shown in FIG. 5C is normalized such that the sum of all elements is 1, thus creating the co-occurrence matrix P.

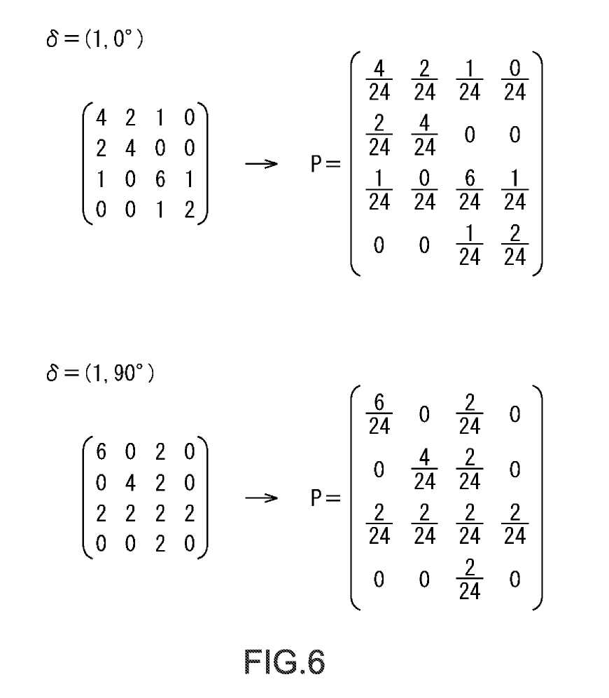

FIG. 6 shows a co-occurrence matrix P of pixels having a positional relation of δ=(1, 0°) and a co-occurrence matrix P of pixels having a positional relation of) δ=(1, 90°) in the difference area shown in FIG. 5A. It should be noted that in the following description, the elements (i, j) of the co-occurrence matrix P are represented by Pᵢⱼ.

In such a manner, when the co-occurrence matrix P is calculated for a certain difference area, the texture similarity determination unit 22 calculates two statistics of an image contrast f_{Contrast} and an image entropy f_{Entropy} by the following equations (1) and (2), using the calculated co-occurrence matrix P of the difference area.

$$\begin{matrix}{f}_{Contrast} = {\sum }_{n} \{ {n}^{2} \cdot {\sum }_{\vert i - j \vert = n} {p}_{ij} \} & ( 1 ) \\ {f}_{Entropy} = - {\sum }_{i} {\sum }_{j} {p}_{ij} log ( {p}_{ij} ) & ( 2 )\end{matrix}$$

The image contrast f_{Contrast} is a statistic that represents a range of variability in brightness between pixels of an image, and the image entropy f_{Entropy} is a statistic that represents uniformity of the image.

The statistics of the image contrast f_{Contrast} and the image entropy f_{Entropy} are obtained for each co-occurrence matrix P. Therefore, for example, assuming that the co-occurrence matrixes P are calculated for four positional relations of δ=(2, 0°), δ=(2,45°), δ=(2, 90°), and δ=(2, 135°) in the real-time image and the past image that correspond to each other in one difference area, obtained are 16 statistics, that is, two images by four positional relations by two statistics. The texture similarity determination unit 22 sets, for one difference area, a vector with a predetermined dimension number obtained as described above (in the above example, 16 dimensions) to be a texture feature amount (vector) of the difference area.

The template-image-feature-amount storage unit 14 stores a texture feature amount for each of a plurality of template images. The texture feature amount is obtained by the same method at a time of determination of a template image.

Then, the texture similarity determination unit 22 determines whether i-th corresponding elements xᵢ and yᵢ of a texture feature amount X of the template image and a texture feature amount Y of the difference area meet the following conditional equation or not.

$$min ( {x}_{i} - C , \frac{{x}_{i}}{r} ) ≦ {y}_{i} ≦ max ( {x}_{i} + C , {rx}_{i} ) \qquad ( 3 )$$

In other words, the texture similarity determination unit 22 determines whether the element yᵢ of the texture feature amount vector of the difference area is included in the range from a smaller value of an element (xᵢ−C) and xᵢ/r to a larger value of an element (xᵢ+C) and rxᵢ of the texture feature amount vector of the template image, for all the elements of the texture feature amount vector of the difference area.

Here, parameters C and r in Equation (3) are constants determined in advance by prepared sample data, as will be described later. It should be noted that when (xᵢ−C) is negative, (xᵢ−C) is replaced with 0.

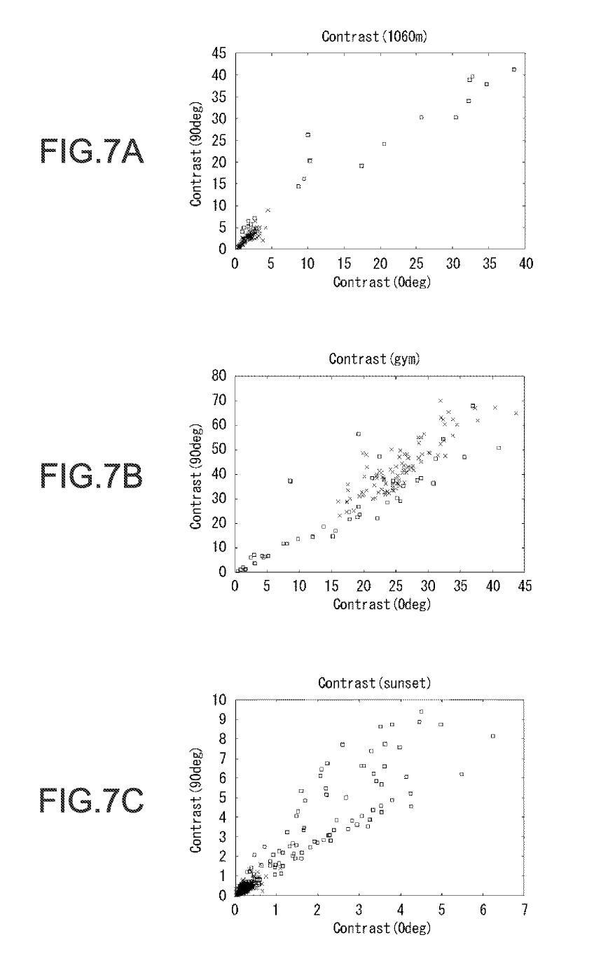

With reference to FIGS. 7A to 12B, the reason why Equation (3) is set as a determination equation of a similarity in texture feature amount between the template image and the difference area will be described.

FIGS. 7A, 7B, and 7C are diagrams in which components (elements) of image contrasts f_{contrast} of δ=(2, 0°) and δ=(2, 90°) are extracted from texture feature amount vectors of a plurality of difference areas detected from three captured image on which different areas to be monitored are captured, to be plotted on a two-dimensional plane.

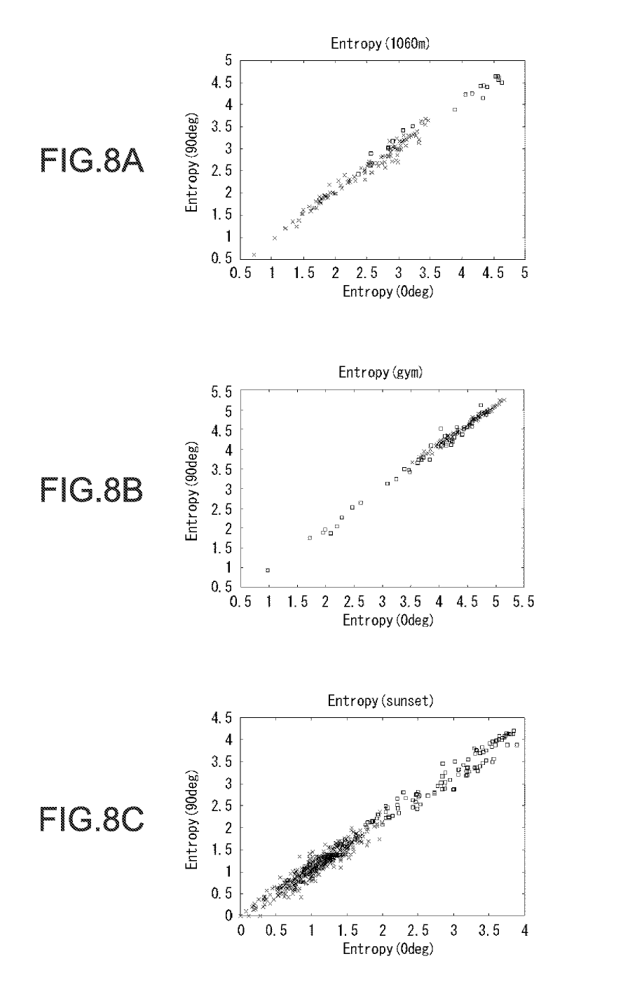

FIGS. 8A, 8B, and 8C are diagram in which components (elements) of image entropies f_{Entropy} of δ=(2, 0°) and δ=(2, 90°) are extracted from the same texture feature amount vectors as those of FIGS. 7A, 7B, and 7C, to be plotted on a two-dimensional plane.

FIGS. 7A and 8A show data of an image of a place distant from the camera 1 by about 1 km in a predetermined direction, which is captured during the day in fine weather. The data contains “the flutter of leaves on a tree” as ambient noise.

In FIGS. 7A and 8A, among a plurality of difference areas obtained by capturing an area to be monitored, a plotted square indicates an object to be ideally detected in the image processing apparatus 2 (for example, human or car). On the other hand, among the plurality of difference areas obtained by capturing the area to be monitored, a plotted cross indicates an erroneous detection due to “the flutter of leaves on a tree” as ambient noise.

FIGS. 7B and 8B show data of an image of a place distant from the camera 1 by about 500 m in a predetermined direction, which is captured during the day in fine weather. The data contains “the flutter of grasses” as ambient noise.

In FIGS. 7B and 8B, among a plurality of difference areas obtained by capturing an area to be monitored, a plotted square indicates an object to be ideally detected in the image processing apparatus 2 (for example, human or car). On the other hand, among the plurality of difference areas obtained by capturing the area to be monitored, a plotted cross indicates an erroneous detection due to “the flutter of grasses” as ambient noise.

FIGS. 7C and 8C show data of an image of a place distant from the camera 1 by about 1 km in a predetermined direction, which is captured in the evening in cloudy weather. The data contains “the welter of a river” as ambient noise.

In FIGS. 7C and 8C, among a plurality of difference areas obtained by capturing an area to be monitored, a plotted square indicates an object to be ideally detected in the image processing apparatus 2 (for example, human or car). On the other hand, among the plurality of difference areas obtained by capturing the area to be monitored, a plotted cross indicate an erroneous detection due to “the welter of a river” as ambient noise.

In each of FIGS. 7A to 8C, one of the plotted crosses representing erroneous detections is registered in the template-image-feature-amount storage unit 14, as a texture feature amount of the template image for erroneous detection.

Therefore, it is desirable to set, as the determination equation for determining a similarity, a determination equation that contains many plotted crosses other than the plotted cross registered in the template-image-feature-amount storage unit 14 and does not contain plotted squares as much as possible in each of FIGS. 7A to 8C.

In this regard, in each of FIGS. 7A to 8C, it is examined whether there is a common feature in the plotted crosses indicating erroneous detections.

In each of FIGS. 7A to 8C, a median value of the distribution of the plotted crosses indicating erroneous detections takes various values including a small one and a large one. For example, a median value of the distribution of the plotted crosses in FIG. 7A is located near a value of 2.5, a median value of the distribution of the plotted crosses in FIG. 7B is located near a value of from 30 to 40, and a median value of the distribution of the plotted crosses in FIG. 7C is located near a value of 0.25.

Additionally, a variability (dispersion) in the distribution of the plotted crosses indicating erroneous detections is small as shown in FIGS. 7A and 7C and is large as shown in FIG. 7B.

However, it is considered that the variability in the distribution of the plotted crosses indicating erroneous detections is relatively proportional to the values of the plotted crosses to some extent. Specifically, in the case where the values of the plotted crosses are small values such as 0 to 5 in FIG. 7A or small values such as 0 to 1 in

FIG. 7C, the variability in the distribution of the plotted crosses is also small. In the case where the values of the plotted crosses are large values such as 30 to 40 in FIG. 7B, the variability in the distribution of the plotted crosses is also large. The same holds true for FIGS. 8A, 8B, and 8C (it seems that FIGS. 8A, 8B, and 8C show a large variability in the distribution, but the values themselves are small).

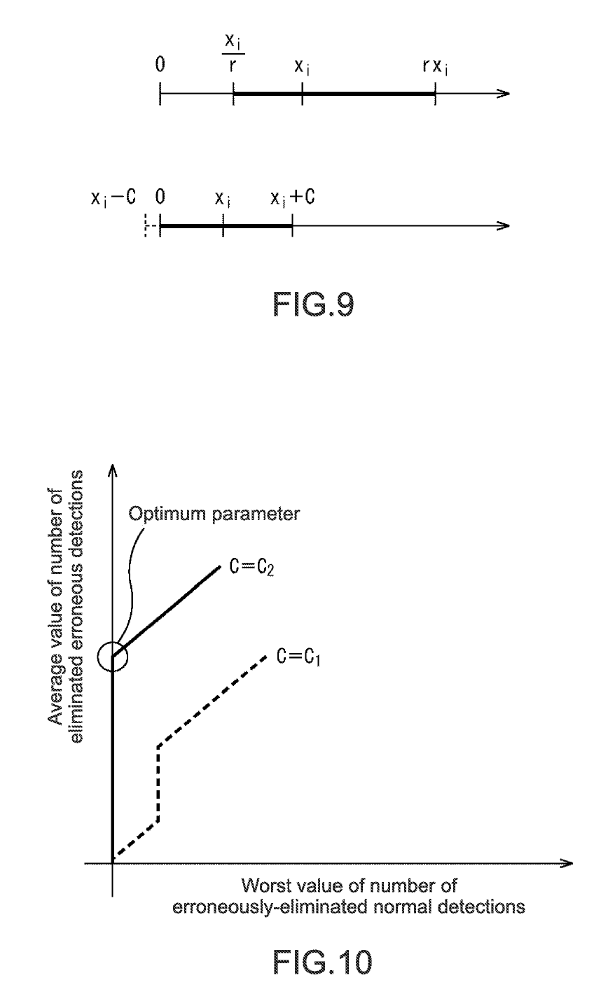

In this regard, as shown in FIG. 9, with the element xᵢ of the texture feature amount vector of the template image registered in template-image-feature-amount storage unit 14 being used as a reference, a range that is set by a difference C based on the reference (xᵢ−C≦yᵢ≦xᵢ+C) and a range that is set by a scaling factor r ((xᵢ/r)≦yᵢrxᵢ) are assumed, and a value included in any one of the ranges is eliminated as one erroneously detected because of the same type as the template image.

In Equation (3), among the two ranges set by the difference C and the scaling factor r shown in FIG. 9, the minimum value side is set by a smaller one of the (xᵢ−C) and (xᵢ/r), and the maximum value side is set by a larger one of the (xᵢ+C) and (rxᵢ).

Next, description will be given on a method of determining the parameters C and r of Equation (3).

Many sample images are prepared. In the prepared sample images, processing of setting the parameters C and r to predetermined values, classifying detected difference areas by normal detection and erroneous detection, and adding up the number of eliminated erroneous detections and the number of erroneously-eliminated normal detections is repeated while the parameters C and r are set to various values. Then, the number of eliminated erroneous detections and the number of erroneously-eliminated normal detections are compared for each of the set parameters C and r, thus determining optimum parameters C and r. It should be noted that the number of template images is constant.

The number of eliminated erroneous detections and the number of erroneously-eliminated normal detections for each of the set parameters C and r are plotted on a two-dimensional plane as shown in FIG. 10, in which a worst value of the number of erroneously-eliminated normal detections is represented on the horizontal axis and an average value of the number of eliminated erroneous detections is represented on the vertical axis. The plotted points of each parameter when the worst value of the number of erroneously-eliminated normal detections is represented on the horizontal axis and an average value of the number of eliminated erroneous detections is represented on the vertical axis represent elimination performance of each parameter. A parameter that has the plotted points distributed in a broken-line manner on the basis of each C value and is located at a higher position on the Y axis of the two-dimensional plane provides higher elimination performance. Experientially, it is suitable to set the parameter C to a value of about 0.5 to 1.0 and the parameter r to a value of about 1.5 to 2.5.

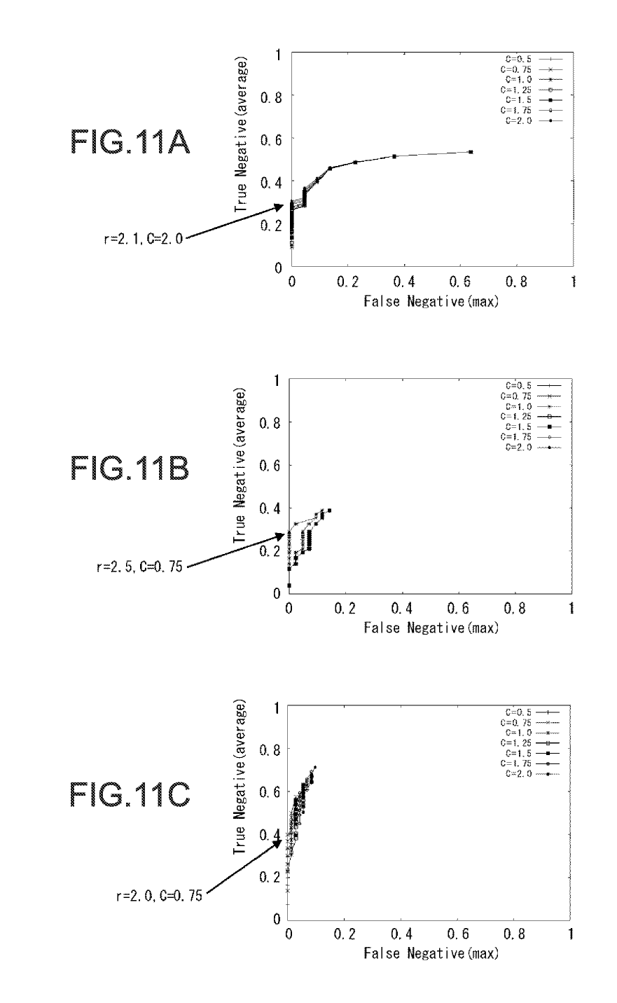

FIGS. 11A, 11B, and 11C each show an elimination performance distribution when the number of registered template images is uniformly set to 20 and the parameters C and r are variously changed for the three different captured images shown in FIGS. 7A to 8C. FIG. 11A corresponds to the captured image used in FIGS. 7A and 8A, FIG. 11B corresponds to the captured image used in FIGS. 7B and 8B, and FIG. 11C corresponds to the captured image used in FIGS. 7C and 8C.

In the case where the parameters C and r are variously changed in the captured image containing “the flutter of leaves on a tree” as ambient noise, which is used in FIGS. 7A and 8A, elimination performance by the parameters is as shown in FIG. 11A. The optimum values of the parameters are r=2.1 and C=2.0.

In the case where the parameters C and r are variously changed in the captured image containing “the flutter of grasses” as ambient noise, which is used in FIGS. 7B and 8B, elimination performance by the parameters is as shown in FIG. 11B. The optimum values of the parameters are r=2.5 and C=0.75.

In the case where the parameters C and r are variously changed in the captured image containing “the welter of a river” as ambient noise, which is used in FIGS. 7C and 8C, elimination performance by the parameters is as shown in FIG. 11C. The optimum values of the parameters are r=2.0 and C=0.75.

Therefore, in the captured images containing different ambient noises, the optimum values of the parameters do not completely coincide. However, as the detection processing, it is desirable to perform uniform processing using one parameter. Therefore, such a parameter will be examined below. In the elimination performance, it is desirable that the worst value of the number of erroneously-eliminated normal detections be zero and the number of eliminated erroneous detections be maximum. In the case where those values are not obtained at the same time, it is only necessary to put a high priority on zero value of the number of erroneously-eliminated normal detections, because missing of an object to be ideally detected should be avoided.

In this regard, the elimination performance is examined using the optimum values of the parameters of FIG. 11C, r=2.0 and C=0.75, in the captured images used in FIGS. 11A and 11B.

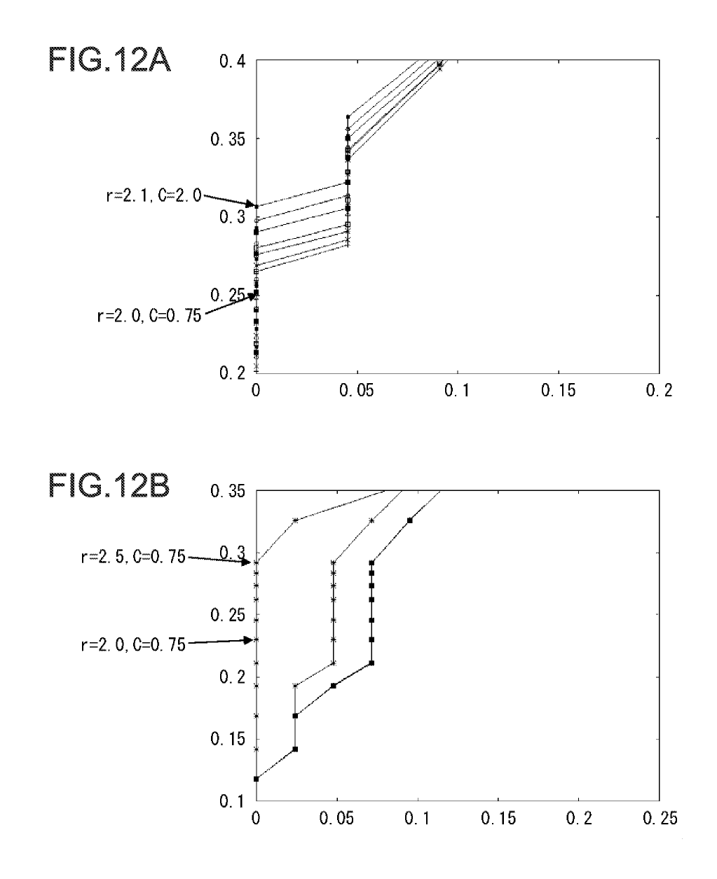

FIG. 12A is an enlarged diagram of the vicinity of the Y axis of FIG. 11A, and FIG. 12B is an enlarged diagram of the vicinity of the Y axis of FIG. 11B.

In the case where the parameters are set to r=2.0 and C=0.75 in the captured image used in FIG. 12A (FIG. 11A), the number of eliminated erroneous detections is slightly reduced compared to the case where r=2.1 and C=2.0, but the worst value of the number of erroneously-eliminated normal detections is kept to be zero, which means that the elimination performance is excellent.

In the case where the parameters are set to r=2.0 and C=0.75 in the captured image used in FIG. 12B (FIG. 11B), the number of eliminated erroneous detections is slightly reduced compared to the case where r=2.5 and C=0.75, but the worst value of the number of erroneously-eliminated normal detections is kept to be zero, which means that the elimination performance is excellent.

From the above description, r=2.0 and C=0.75, which correspond to various ambient noises such as “the flutter of leaves on a tree”, “the flutter of grasses”, and “the welter of a river”, can be determined to be common parameters.

In the case where the conditions of the determination equation as Equation (3) using the parameters determined as described above are satisfied for all the elements of the texture feature amount vector of the difference area, the texture similarity determination unit 22 determines that the texture feature amount of the template image and that of the difference area are similar to each other.

(Color Similarity Determination Processing By Color Similarity Determination Unit 23)

Next, color similarity determination processing by the color similarity determination unit 23 will be described.

The color similarity determination unit 23 converts the real-time image of the difference area into a YUV color space and creates a two-dimensional histogram of U and V of the difference area. Then, the color similarity determination unit 23 determines a similarity between the two-dimensional histogram of U and V of the difference area and a two-dimensional histogram of U and V of the template image.

Specifically, when the two-dimensional histogram of the difference area is represented by a vector v and the two-dimensional histogram of the template image is represented by a vector w, the color similarity determination unit 23 calculates a similarity between the histogram of the difference area and that of the template image by using the following correlation factor d (v,w);

$$d ( v , w ) = \frac{〈 v , w 〉}{\vert v \vert \vert w \vert} ≦ α \qquad ( 4 )$$

where |•| of the denominator represents an absolute value, and |v|=(v₁²+v₂²+ •••vₖ²)^{1/2} and |w|=(w₁²+w₂²+ •••wₖ²)^{1/2}. Further, the numerator <v,w> represents an inner product of the vector v and the vector w. It should be noted that the vector w of the two-dimensional histogram of the template image is stored in the template-image-feature-amount storage unit 14.

A threshold value α for determining that the difference area and the template image have a similarity in color is set to 0.7≈cos 45°, for example. In the case where the correlation factor d (v,w) is equal to or smaller than the threshold value α, the color similarity determination unit 23 determines that the difference area and the template image have a similarity in color feature amount.

Here, the U and V values in each of the template image and the difference area converted into the YUV color space are set to be a value segmented in 32 gradations, for example, thus simplifying the calculation of the correlation factor of the histograms.

(Flowchart of Object Detection Processing)

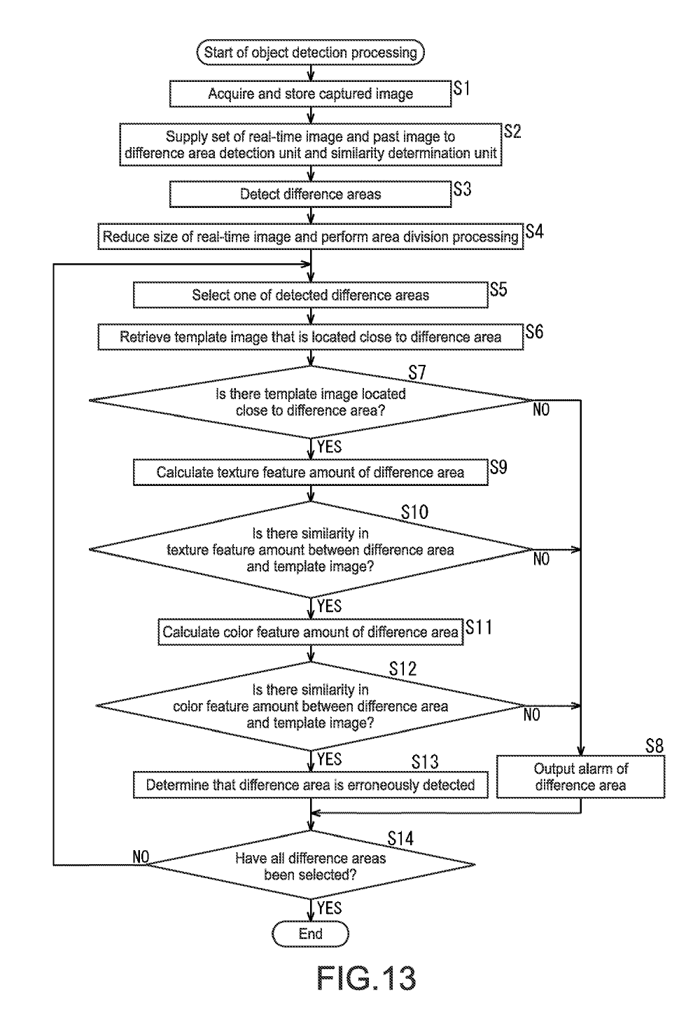

Next, with reference to a flowchart of FIG. 13, object detection processing of the image processing apparatus 2 will be described. This processing is started when, for example, a real-time image is supplied from the camera 1.

First, in Step S1, the captured-image acquisition unit 11 acquires a real-time image that is captured latest and input from the camera 1, and then stores the real-time image in the buffer 11A for a certain period of time. It should be noted that the period of time in which the buffer 11A stores the real-time image can be set to be, for example, a period of time until an image captured just at that moment is output as a past image.

In Step S2, the captured-image acquisition unit 11 supplies a set of the real-time image, which is input from the camera 1, and a past image, which is input from the camera 1 one image before the real-time image, to the difference area detection unit 12 and the similarity determination unit 13.

In Step S3, the difference area detection unit 12 compares the real-time image and the past image supplied from the captured-image acquisition unit 11 and detects a difference area in which a difference in pixel value between corresponding pixels of the images is equal to or larger than a predetermined threshold value. In general, a plurality of difference areas are detected, and information indicating the detected difference areas is supplied to the similarity determination unit 13.

In Step S4, the positional proximity determination unit 21 of the similarity determination unit 13 reduces the size of the real-time image supplied from the captured-image acquisition unit 11 and performs area division processing of dividing the size-reduced real-time image into areas based on similar colors.

In Step S5, the positional proximity determination unit 21 selects a predetermined difference area from among the difference areas detected in the difference area detection unit 12.

In Step S6, the positional proximity determination unit 21 retrieves a template image that is located close to the selected difference area, based on position information of the template image stored in the template-image-feature-amount storage unit 14.

In Step S7, the positional proximity determination unit 21 determines whether there is a template image located close to the selected difference area by the method described with reference to FIG. 3.

When it is determined in Step S7 that there is no template image located close to the selected difference area, the processing proceeds to Step S8. The positional proximity determination unit 21 supplies information indicating that a difference area has been detected to the alarm output unit 15. The alarm output unit 15 outputs an alarm indicating that a difference area has been detected, based on the information from the positional proximity determination unit 21.

On the other hand, when it is determined in Step S7 that there is a template image located close to the selected difference area, the processing proceeds to Step S9. The texture similarity determination unit 22 of the similarity determination unit 13 calculates a texture feature amount (vector) of the selected difference area.

Then, in Step S10, the texture similarity determination unit 22 determines whether there is a similarity in texture feature amount between the selected difference area and the template image determined to be located close to the selected difference area.

Specifically, the texture similarity determination unit 22 acquires a texture feature amount vector of the template image that has been determined to be located close to the selected difference area, from the template-image-feature-amount storage unit 14. Then, the texture similarity determination unit 22 determines whether all elements of the feature amount vector of the selected difference area and the texture feature amount vector of the template image located close thereto meet the determination equation of Equation (3) or not. In the case where all the elements of the texture feature amount vectors meet the determination equation of Equation (3), it is determined that there is a similarity in texture feature amount between the selected difference area and the template image that has been determined to be located close thereto.

When it is determined in Step S10 that there is no similarity in texture feature amount between the selected difference area and the template image that has been determined to be located close thereto, the processing proceeds to Step S8 described above. Therefore, also in this case, the alarm output unit 15 outputs an alarm indicating that the difference area has been detected.

On the other hand, when it is determined in Step S10 that there is a similarity in texture feature amount between the selected difference area and the template image that has been determined to be located close thereto, the processing proceeds to Step S11. The color similarity determination unit 23 calculates a color feature amount of the selected difference area. Specifically, the color similarity determination unit 23 converts the real-time image of the selected difference area into a YUV color space and creates a two-dimensional histogram of U and V of the selected difference area.

Then, in Step S12, the color similarity determination unit 23 determines whether there is a similarity in color feature amount between the selected difference area and the template image that is located close thereto and has been determined to have a similarity in texture feature amount as well.

Specifically, the color similarity determination unit 23 acquires a color feature amount of the template image that is located close to the selected difference area and has been determined to have a similarity in texture feature amount (two-dimensional histogram of U and V) from the template-image-feature-amount storage unit 14. Then, the color similarity determination unit 23 calculates a correlation factor d (v,w) of a two-dimensional histogram v serving as the color feature amount of the selected difference area and a two-dimensional histogram w serving as the color feature amount of the template image that is located close to the selected difference area and has been determined to have a similarity in texture feature amount as well. Then, the color similarity determination unit 23 determines whether the calculated correlation factor d (v,w) is equal to or smaller than a preset threshold value α. When it is determined that the calculated correlation factor d (v,w) is equal to or smaller than the threshold value α, the color similarity determination unit 23 determines that there is a similarity in color feature amount.

When it is determined in Step S12 that there is no similarity in color feature amount between the selected difference area and the template image that is located close to the selected difference area and has been determined to have a similarity in texture feature amount as well, the processing proceeds to Step S8 described above. Therefore, also in this case, the alarm output unit 15 outputs an alarm indicating that the difference area has been detected.

On the other hand, when it is determined in Step S12 that there is a similarity in color feature amount between the selected difference area and the template image that is located close to the selected difference area and has been determined to have a similarity in texture feature amount as well, the processing proceeds to Step S13.

In Step S13, the color similarity determination unit 23 determines that the selected difference area is an erroneously-detected area because of the same type as the template image stored in the template-image-feature-amount storage unit 14, and an alarm is not output for the selected difference area.

After Step S8 or Step S13 described above, the processing proceeds to Step S14. The similarity determination unit 13 determines whether all the difference areas detected in the difference area detection unit 12 have been selected.

When it is determined in Step S14 that all the difference areas detected in the difference area detection unit 12 have been selected, the processing returns to Step S5, and the processing from Step S5 to S14 described above is repeated. In other words, of the difference areas detected in the difference area detection unit 12, a difference area that has not yet been selected is selected and it is determined whether the selected difference area has a similarity to the template image stored in the template-image-feature-amount storage unit 14 in feature amounts of position, texture, and color.

On the other hand, it is determined in Step S14 that all the difference areas detected in the difference area detection unit 12 have been selected, the processing of FIG. 13 is terminated.

According to the object detection processing described above, using the feature amount of the template image stored in the template-image-feature-amount storage unit 14, it is determined whether the detected difference area has a similarity to the template image for erroneous detection, in the feature amounts of position, texture, and color. An alarm is not output to a difference area determined to have a similarity to the template image for erroneous detection. Thus, the erroneous detection of ambient noises such as “the flutter of leaves on a tree”, “the flutter of grasses”, and “the welter of a river” can be reduced, and detection accuracy of the monitoring camera system can be increased.

In the image processing apparatus 2, in order to reduce the erroneous detection of ambient noise, the feature amounts of a predetermined number of template images only need to be stored. Therefore, it is unnecessary to store a large number of past images. Thus, a monitoring system with high detection accuracy can be achieved in a simpler configuration than the technique disclosed in Japanese Patent Application Laid-open No. 2000-156852 described above.

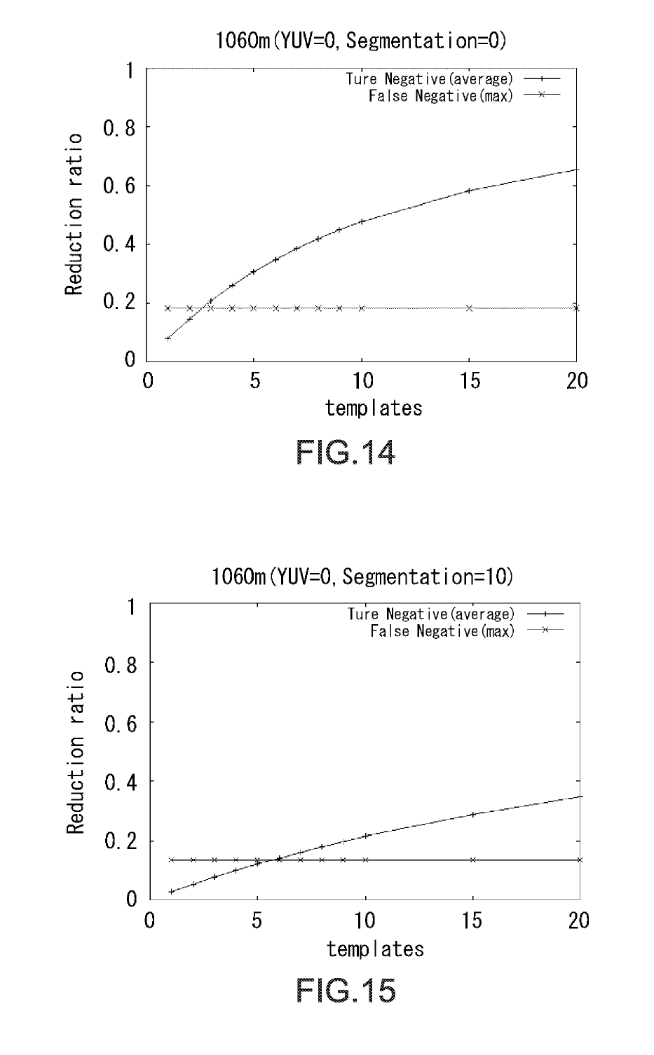

In the embodiment described above, using all the three feature amounts of position, texture, and color, it is determined whether a difference area is erroneously detected or not because of the same type as the template image. FIGS. 14 to 19 show results of comparison in detection accuracy with the case where erroneous detection is determined using one or two of the three feature amounts.

The horizontal axis of FIGS. 14 to 19 represents the number of registration of (feature amounts of) template images, and the vertical axis thereof represents a worst value of the number of erroneously-eliminated normal detections and an average value of the number of eliminated erroneous detections. Of points plotted in the figures, a plotted cross represents a worst value of the number of erroneously-eliminated normal detections, and a plotted plus represents an average value of the number of eliminated erroneous detections.

FIG. 14 shows detection accuracy when it is determined whether a selected difference area is erroneously detected or not because of the same type as the template image by using only a feature amount in texture.

FIG. 15 shows detection accuracy when it is determined whether a selected difference area is erroneously detected or not because of the same type as the template image by using two feature amounts of position and texture.

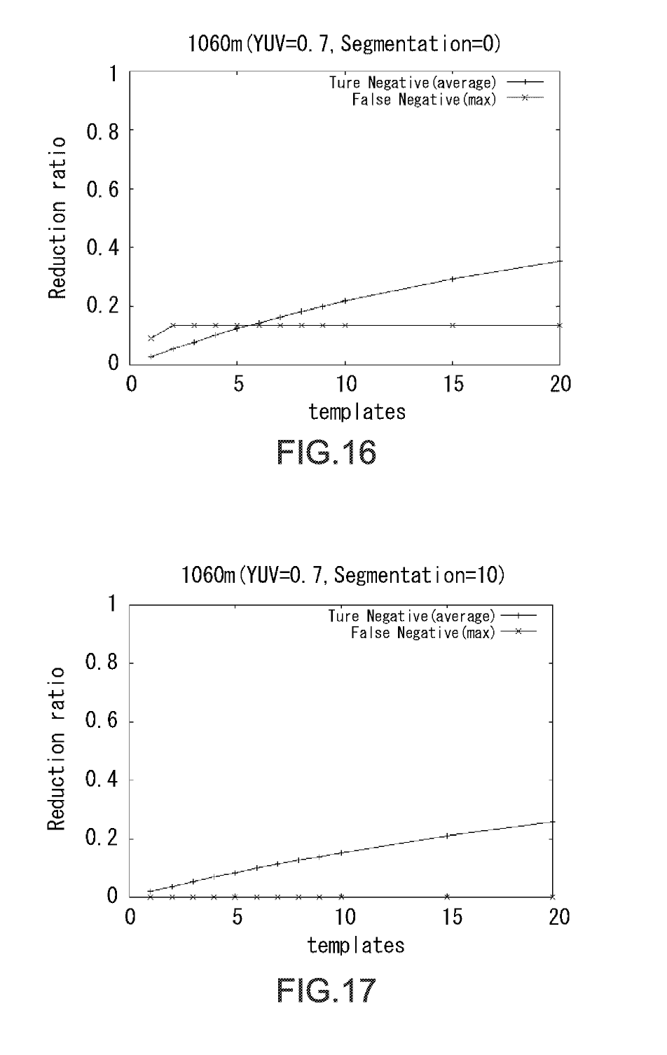

FIG. 16 shows detection accuracy when it is determined whether a selected difference area is erroneously detected or not because of the same type as the template image by using two feature amounts of texture and color.

FIG. 17 shows detection accuracy when it is determined whether a selected difference area is erroneously detected or not because of the same type as the template image by using the three feature amounts of position, texture, and color.

With reference to FIGS. 14 to 17, the erroneous detection determination using the three feature amounts of position, texture, and color allows the number of erroneously-eliminated normal detections to be made smaller (reduced to be zero).

FIGS. 14 to 17 show results of comparison in which feature amounts to be used in the erroneous detection determination are changed for the captured image containing “the flutter of leaves on a tree” as ambient noise, which is used in FIGS. 7A and 8A. Regarding the captured image used in FIGS. 7B and 8B and the captured image used in FIGS. 7C and 8C, only results obtained in the case where the erroneous detection determination is performed using the three feature amounts of position, texture, and color will be shown.

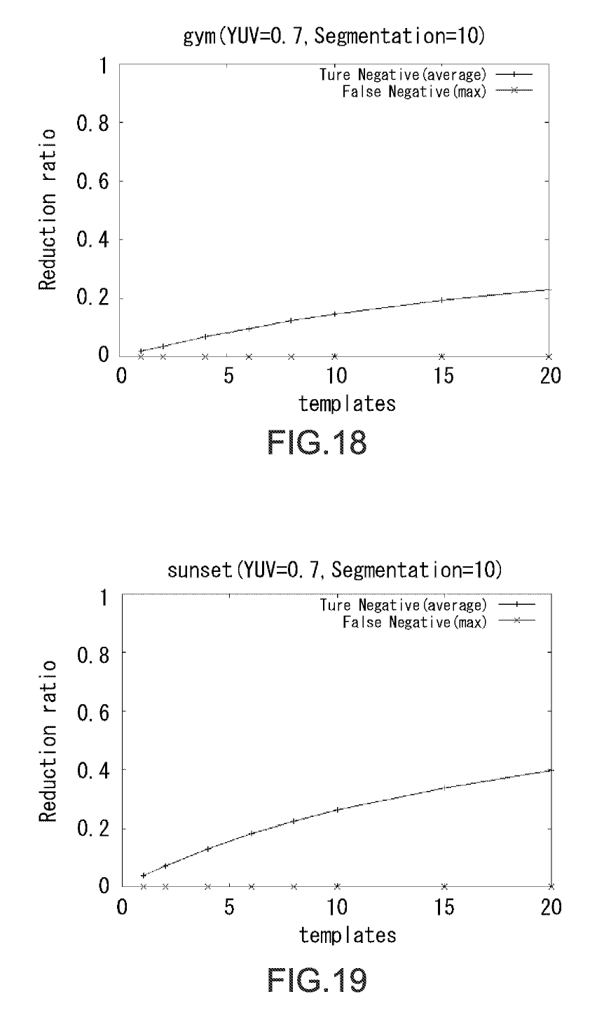

FIG. 18 shows detection accuracy when it is determined whether the captured image containing “the flutter of grasses” as ambient noise, which is used in FIGS. 7B and 8B, is erroneously detected or not because of the same type as the template image, by using the feature amounts of position, texture, and color.

FIG. 19 shows detection accuracy when it is determined whether the captured image containing “the welter of a river” as ambient noise, which is used in FIGS. 7C and 8C, is erroneously detected or not because of the same type as the template image, by using the feature amounts of position, texture, and color.

The erroneous detection determination is performed for the captured images used in FIGS. 18 and 19 by using the three feature amounts of position, texture, and color. Thus, the number of erroneously-eliminated normal detections can be made smaller (reduced to zero).

### 2. Second Embodiment

Next, a monitoring camera system according to a second embodiment will be described.

In the first embodiment described above, the case where the camera 1 constantly captures images in one imaging range serving as an area to be monitored, with a position, an orientation, an angle, and the like being fixed, has been described.

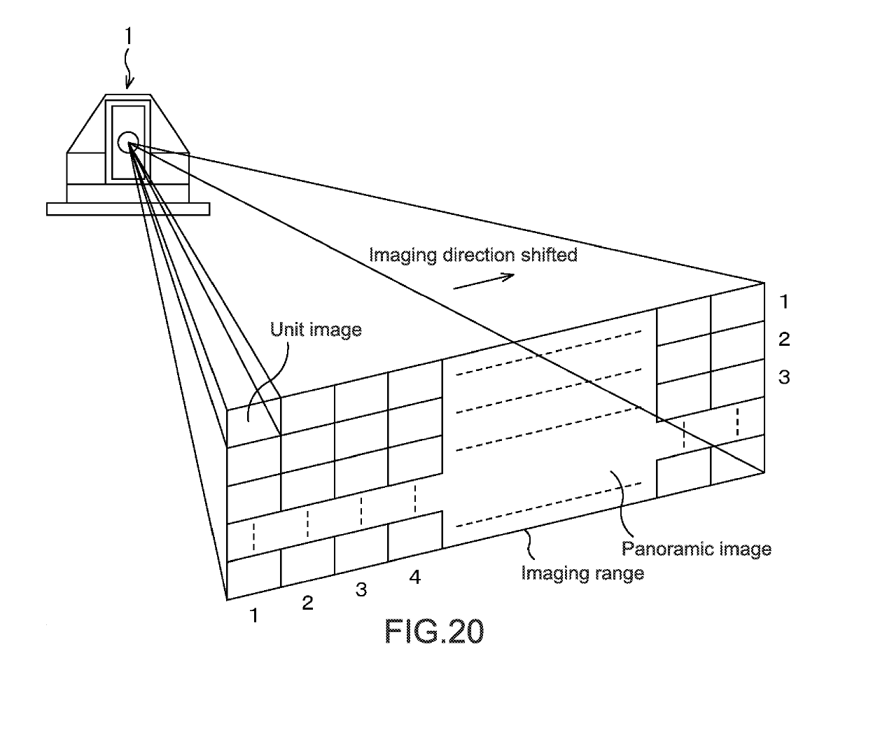

In the second embodiment, as shown in FIG. 20, the camera 1 is assumed to have a zoom mechanism (telescopic mechanism), be movable in a horizontal direction and a vertical direction, and form a panoramic image by connecting unit images in the horizontal direction and vertical direction to one another, the unit images being obtained in one-time imaging. That is, the camera 1 is assumed to have a wide and long-distance imaging range. For example, the camera 1 can be configured to have an area to be monitored in the range of 270 degrees at maximum and have a capability of detecting a car in a distance of 5 km or a person in a distance of 1 km.

In the case where the camera 1 has an wide area to be monitored as described above, it is considered that a value of the texture feature amount or the form of variability largely differs between a case where an object is located far away and a case where an object is located near, even if the object (for example, the flutter of leaves on a tree) that is prone to be detected as a difference area is the same in both the cases.

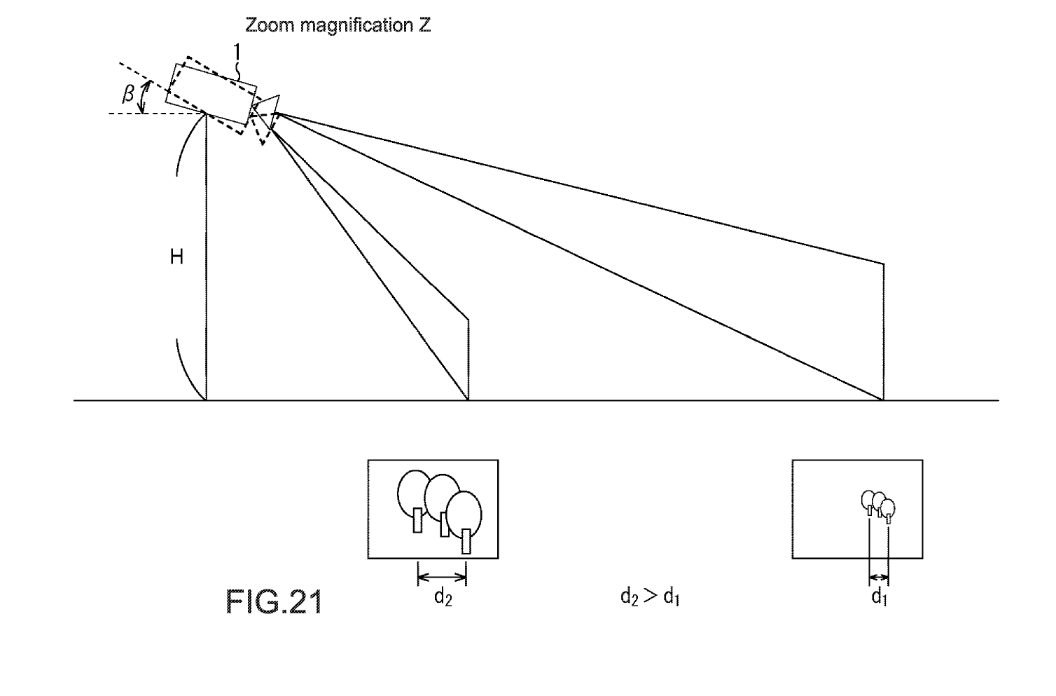

In this regard, the texture similarity determination unit 22 of the image processing apparatus 2 changes a value of the distance d in accordance with the distance from the camera 1 to the area to be monitored, in the similarity determination of the texture feature amount. The distance d is a parameter that indicates a positional relation between a pixel i and a pixel j that are used to calculate a co-occurrence matrix P. Specifically, as shown in FIG. 21, as a distance from the camera 1 to the area to be monitored is increased, the value of the distance d is set to a smaller value. Thus, in both the cases where an object is located far away and where an object is located near, erroneous detection of images having the same type as one registered as a template image can be eliminated uniformly.

The distance from the camera 1 to the area to be monitored can be estimated based on the height H at which the camera 1 is installed, a depression angle β of the camera 1, and a zoom magnification Z. Therefore, the texture similarity determination unit 22 holds a table in which a distance d used when a co-occurrence matrix P is calculated is stored, in accordance with the height H, the depression angle β of the camera 1, and the zoom magnification Z of the camera 1. By referring to the table, the texture similarity determination unit 22 changes the distance d in accordance with the height H of the camera 1 that is stored as installation information, and the current depression angle β and zoom magnification Z.

Generally, once the camera 1 is installed at a predetermined position, the camera 1 is basically fixed except for a case of stopping monitoring or the like. Therefore, since the height H of the camera 1 can be assumed as a fixed value, the table of the distance d that is caused to correspond to only the depression angle β and the zoom magnification Z of the camera 1 may be held in consideration of the height H of the camera 1 at the installation position.

Conversely, a value of the distance d when the co-occurrence matrix P is calculated is kept to be constant irrespective of the distance from the camera 1 to the area to be monitored. Thus, the setting of the erroneous detection can be changed between the case where an object is located far away and the case where an object is located near. For example, such a setting that an erroneous detection of an image having the same type as the template image is made in a large distance while it is not made in a close distance, can be made.

When the template images for erroneous detection are grouped by the types of erroneous detections such as “the flutter of leaves on a tree”, “the flutter of grasses”, and “the welter of a river”, a distance to the area to be monitored, and the like, it is thought that a ratio of the value of the texture feature amount to the range of variability is often in the same range among the groups. Therefore, it is assumed that even if an identical value is set for a threshold value for determining a similarity in texture feature amount without finely setting the threshold value for each template image, excellent elimination performance can be obtained.

The series of processing described above can be executed by hardware or software. In the case where the series of processing is executed by software, programs constituting the software are installed in a computer. Here, the computer includes a computer incorporated in dedicated hardware, a general-purpose personal computer that can execute various functions by installing various programs, and the like.

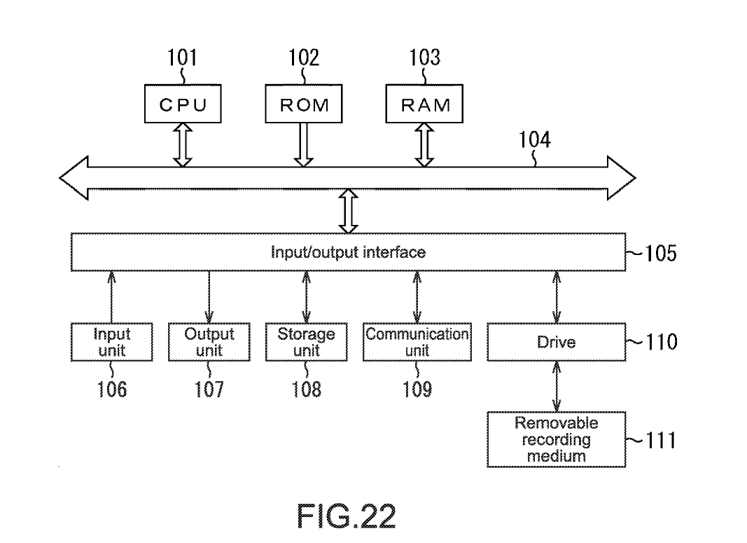

FIG. 22 is a block diagram showing a configuration example of hardware of a computer that executes the series of processing described above by a program.

In the computer, a CPU (Central Processing Unit) 101, a ROM (Read Only Memory) 102, a RAM (Random Access Memory) 103 are connected to one another by a bus 104.

The bus 104 is also connected with an input/output interface 105. An input unit 106, an output unit 107, a storage unit 108, a communication unit 109, and a drive 110 are connected to the input/output interface 105.

The input unit 106 includes a keyboard, a mouse, microphones, and the like. The output unit 107 includes a display, a speaker, and the like. The storage unit 108 includes a hard disk, a non-volatile memory, and the like. The communication unit 109 includes a network interface and the like. The drive 110 drives a removable recording medium 111 such as a magnetic disc, an optical disc, a magneto-optical disc, or a semiconductor memory.

In the computer configured as described above, for example, the CPU 101 loads a program stored in the storage unit 108 to the RAM 103 via the input/output interface 105 and the bus 104 for execution, thus performing the series of processing described above.

In the computer, the program can be installed in the storage unit 108 via the input/output interface 105 by mounting the removable recording medium 111 into the drive 110. Further, the program can be received in the communication unit 109 via a wireless or wired transmission medium such as a local area network, the Internet, and digital satellite broadcasting and then installed in the storage unit 108. In addition, the program can be installed in advance in the ROM 102 or the storage unit 108.

It should be noted that in the specification, the steps described in the flowchart may be executed chronologically along the described order or may be executed at necessary timings such as when processing is performed in parallel or an invocation is performed without necessarily performing chronological processing.

In this specification, the system means an assembly of a plurality of constituent elements (apparatus, module (part), and the like) and it does not matter whether all the constituent elements are provided in one casing or not. Therefore, a plurality of apparatuses that are housed in different casings and connected to one another via a network, and one apparatus including a plurality of modules in one casing are each referred to as a system.

The embodiments of the present disclosure are not limited to the embodiments described above and can be variously modified without departing from the gist of the present disclosure.

For example, an embodiment in which all the plurality of embodiments described above or parts thereof are combined can be adopted.

For example, the present disclosure can have a configuration of cloud computing in which a plurality of apparatuses share one function and cooperate to perform processing via a network.

Further, the steps described in the flowchart described above can be executed by one apparatus or shared and executed by a plurality of apparatuses.

In addition, in the case where one step includes a plurality of processing steps, the plurality of processing steps can be executed by one apparatus or shared and executed by a plurality of apparatuses.

It should be noted that the present disclosure can take the following configurations.
(1) An image processing apparatus, including:

a difference area detection unit configured to detect a difference area of an input image; and

a similarity determination unit configured to calculate a feature amount of a difference area image that is an image of the detected difference area and determine a similarity between the calculated feature amount of the difference area image and a feature amount of a template image for erroneous detection, to determine whether the difference area image is erroneously detected or not.
(2) The image processing apparatus according to (1), in which

the similarity determination unit is configured to calculate, as the feature amount of the difference area image, a texture feature amount using a co-occurrence matrix of luminance values within the image, and determine a similarity in the texture feature amount.
(3) The image processing apparatus according to (2), in which

the texture feature amount includes a statistic that represents a range of variability in brightness between pixels of the image and a statistic that represents uniformity of the image.
(4) The image processing apparatus according to (2) or (3), in which

the similarity determination unit is configured to determine whether an element of a vector of the texture feature amount of the difference area image falls within a predetermined range of a corresponding element of a vector of a texture feature amount of the template image, to determine a similarity of the feature amount.
(5) The image processing apparatus according to any one of (2) to (4), in which

the similarity determination unit is configured to change a distance parameter used for determining a distance between two pixels when the co-occurrence matrix is calculated, in accordance with distance information of a distance from an imaging apparatus to an object to be imaged, the imaging apparatus having captured the input image.
(6) The image processing apparatus according to (5), in which

the distance information is determined in accordance with installation information, a depression angle, and a zoom magnification of the imaging apparatus.
(7) The image processing apparatus according to any one of (1) to (6), further including a template-image-feature-amount storage unit configured to store the feature amount of the template image for erroneous detection.
(8) The image processing apparatus according to any one of (1) to (7), in which

the similarity determination unit is configured to determine positional proximity between the difference area image and the template image, as a determination of the similarity in the feature amount.
(9) The image processing apparatus according to any one of (1) to (8), in which

the similarity determination unit is configured to determine a color similarity between the difference area image and the template image, as a determination of the similarity in the feature amount.
(10) The image processing apparatus according to any one of (1) to (9), in which

the input image includes an image that is captured and input with a monitoring camera.
(11) An image processing method, including:

by an image processing apparatus,

detecting a difference area of an input image; and

calculating a feature amount of a difference area image that is an image of the detected difference area and determining a similarity between the calculated feature amount of the difference area image and a feature amount of a template image for erroneous detection, to determine whether the difference area image is erroneously detected or not.
(12) A program causing a computer to function as:

a difference area detection unit configured to detect a difference area of an input image; and

a similarity determination unit configured to calculate a feature amount of a difference area image that is an image of the detected difference area and determine a similarity between the calculated feature amount of the difference area image and a feature amount of a template image for erroneous detection, to determine whether the difference area image is erroneously detected or not.

The present disclosure contains subject matter related to that disclosed in Japanese Priority Patent Application JP 2012-165427 filed in the Japan Patent Office on Jul. 26, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
a difference area detection unit configured to detect a difference area of an input image; and
a similarity determination unit configured to calculate a feature amount of a difference area image that is an image of the detected difference area and determine a similarity between the calculated feature amount of the difference area image and a feature amount of a template image for erroneous detection, to determine whether the difference area image is erroneously detected or not.

2. The image processing apparatus according to claim 1, wherein
the similarity determination unit is configured to calculate, as the feature amount of the difference area image, a texture feature amount using a co-occurrence matrix of luminance values within the image, and determine a similarity in the texture feature amount.

3. The image processing apparatus according to claim 2, wherein
the texture feature amount includes a statistic that represents a range of variability in brightness between pixels of the image and a statistic that represents uniformity of the image.

4. The image processing apparatus according to claim 2, wherein
the similarity determination unit is configured to determine whether an element of a vector of the texture feature amount of the difference area image falls within a predetermined range of a corresponding element of a vector of a texture feature amount of the template image, to determine a similarity of the feature amount.

5. The image processing apparatus according to claim 2, wherein
the similarity determination unit is configured to change a distance parameter used for determining a distance between two pixels when the co-occurrence matrix is calculated, in accordance with distance information of a distance from an imaging apparatus to an object to be imaged, the imaging apparatus having captured the input image.

6. The image processing apparatus according to claim 5, wherein
the distance information is determined in accordance with installation information, a depression angle, and a zoom magnification of the imaging apparatus.

7. The image processing apparatus according to claim 1, further comprising a template-image-feature-amount storage unit configured to store the feature amount of the template image for erroneous detection.

8. The image processing apparatus according to claim 2, wherein
the similarity determination unit is configured to determine positional proximity between the difference area image and the template image, as a determination of the similarity in the feature amount.

9. The image processing apparatus according to claim 2, wherein
the similarity determination unit is configured to determine a color similarity between the difference area image and the template image, as a determination of the similarity in the feature amount.

10. The image processing apparatus according to claim 1, wherein
the input image includes an image that is captured and input with a monitoring camera.

11. An image processing method, comprising:
by an image processing apparatus,
detecting a difference area of an input image; and
calculating a feature amount of a difference area image that is an image of the detected difference area and determining a similarity between the calculated feature amount of the difference area image and a feature amount of a template image for erroneous detection, to determine whether the difference area image is erroneously detected or not.

12. A program causing a computer to function as:
a difference area detection unit configured to detect a difference area of an input image; and
a similarity determination unit configured to calculate a feature amount of a difference area image that is an image of the detected difference area and determine a similarity between the calculated feature amount of the difference area image and a feature amount of a template image for erroneous detection, to determine whether the difference area image is erroneously detected or not.
